(19) United States
(12) Patent Application Publication
(10) Pub. No.: US 2016/0154854 A1
(43) Pub. Date: Jun. 2, 2016

(54) TOP-K Prefix Histogram Construction for String Data

(71) Applicants: Ge LOU, (US); Li-Mei JIAO, (US); Zhao CAO, (US); Shimin CHEN, (US); Meng GUO, (US); HEWLETT-PACKARD DEVELOPMENT COMPANY, L.P., Houston, TX (US)

(72) Inventors: Ge LUO, Hong Kong (CN); Li-Mei JIAO, Beijing (CN); Zhao CAO, Beijing (CN); Shimin CHEN, Beijing (CN); Weng GUO, Shanghai (CN)

(73) Assignee: Hewlett-Packard Development Company, L.P., Houston, TX (US)

(21) Appl. No.: 14/787,548

(22) PCT Filed: Apr. 30, 2013
(86) PCT No.: PCT/CN2013/075033

§ 371 Date: Oct. 28, 2015

(51) Int. Cl. G06F 17/30

(52) U.S. Cl. CPC G06F 17/30516; G06F 17/3053; G06F 17/30345; G06F 17/30327

(57) ABSTRACT

Methods and systems of generation of histograms for strings are described. In one implementation, a prefix tree having nodes representing prefixes of the strings is generated. For the prefix tree, deploy weights are assigned to the nodes based on lengths of the prefixes represented by sub-tree nodes rooted at the nodes and frequencies of the strings whose prefixes are represented by the sub-tree nodes. Each of the deploy weights of one node is indicative of a maximum weight preserved upon filling the buckets with at least one prefix represented by the sub-tree nodes rooted at that one node. A predefined number of Top-prefixes are determined for filling up the predefined number of buckets. The Top-prefixes are determined based on maximizing a total weight preserved by the prefixes in the buckets and over a maximum number of strings. A histogram is generated based on the deploy weights associated with the Top-prefixes.

### BACKGROUND

In modern day environments, large volumes of data are generally captured from a variety of information sources, and managed in databases for various purposes including data analysis and database searching. In view of the large volume of data, database management systems utilize histograms to capture data distribution, to summarize and represent the data in a concise form. To generate a histogram, the data is partitioned based on a degree of similarity in their characteristics. The histogram, in an example, represents a frequency distribution of occurrence of data with similar characteristics over the entire data.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1(a) illustrates a system environment implementing a histogram construction system, according to an example of the present subject matter.

FIG. 1(b) illustrates a histogram construction system, according to an example of the present subject matter.

FIG. 2 illustrates the histogram construction system, according to an example of the present subject matter.

FIG. 3 illustrates a prefix tree for string data, according to an example of the present subject matter.

FIGS. 4(a), 4(b), 4(c), 4(d), and 4(e) illustrate iterative revisions of a prefix tree for strings in an online environment, according to an example of the present subject matter.

FIG. 5 illustrates a prefix tree for strings in an offline environment, according to an example of the present subject matter.

FIG. 6 illustrates a method of generation of a histogram for string data, according to an example of the present subject matter.

FIG. 7 illustrates a method of generation of a histogram for string data in an online environment, according to an example of the present subject matter.

FIG. 8 illustrates a method of generation of a histogram for string data in an offline environment, according to an example of the present subject matter.

FIG. 9 illustrates a system environment for generation of a histogram for string data, according to an example of the present subject matter.

### DETAILED DESCRIPTION

The present subject matter relates to methods and systems for generation of histograms for string data. The string data include multiple sequences of characters in the form of strings. A histogram represents a statistical summary of the string data, which may be generated based on a frequency distribution of strings in the string data.

A histogram is generated by sampling of data into multiple buckets, where each bucket is filled with the data having similar characteristics. Each bucket generally has a defined bucket boundary or sampling span for filling up the data in that bucket. For example, the data may correspond to age of employees in a company. The age data can be sampled into buckets of different age spans. The buckets may have equal or unequal boundary widths. Each bucket may store frequency of occurrence of data lying within the respective bucket boundary. The frequency distribution stored in the buckets summarizes the data, which is referred to as a histogram synopsis. The histogram synopsis can then be used to generate a histogram for the data over the buckets.

Histograms of data find their utility in various applications, such as data mining, data analytics, and approximate query answering. Histograms enable in storing the data and its relevant information in compact and concise manner, which in turn facilitate in improving the performance of data mining, data analytics and approximate query answering procedures when performed over the histograms. For data mining and big data analytics, it is possible to fetch required information, draw inferences and identify deviations in the data distribution in a substantially quick time through the histograms. In approximate query answering, user queries can be executed on the histograms, instead of on the entire data, to obtain approximate but quick answers to the user queries.

Presently available databases and applications deal with different types of data including numerical and string based data. Methods of generation of histograms for numerical data are common; however, such numerical data specific methods cannot be applied for generation of histograms for string data. Also, histogram generation methods are applicable on static data, i.e., on the data that is fixed and known prior to generation of histograms. Such methods cannot be used for generation of histograms for the data being streamed online in real-time.

Further, generating histograms have computation costs associated with them. The computation costs generally include time cost and space cost. The time cost refers to the amount of time taken for generation of a histogram, and the space cost refers to the amount of space, i.e., the memory utilized by a histogram. The methods of generation of histograms for the string data typically take time in a quadratic order of number of data values being considered for the histogram generation, i.e., O(|n²|) where n is the number of data values. With the number of data values being substantially large, the time cost of the histogram is substantially high. The histogram generally takes space in a linear order of number of data values, i.e., O(|n|) where n is the number of data values for which the histogram is generated. For the histogram generated over a large number of data values, the space cost is also substantially large.

Methods and systems for generation of histograms for string data are described herein. With the methods and the systems of the present subject matter, histograms can be generated for string data which is static and predefined, and for string data which is streamed online in real-time. The histograms that are generated based on the methods and the systems of the present subject matter have substantially low time and space costs associated with them.

In accordance with the present subject matter, for generation of a histogram for string data, the strings in the string data are represented as a prefix tree. A prefix tree is a Trie data structure having nodes that represent prefixes of the strings. A prefix of a string is a sequence of characters which is either the same as that of the string or which is a substring of the string. The nodes in the prefix tree represent longest prefixes and longest common prefixes of the strings. A longest prefix refers to a sequence of characters which is equal to a string. A longest common prefix refers to a sequence of characters which is a common substring of one or more strings. For example, for two strings “host” and “hostname”, the prefix tree will have a node representing the longest prefix as “host” for the string “host”, a node representing the longest prefix as “hostname” for the string “hostnames”, and a node representing the longest common prefix as “host” for the both strings.

Based on the prefix tree, deploy weights are assigned to the nodes in the prefix tree. A deploy weight of a node is computed based on lengths of the prefixes represented by sub-tree nodes rooted at that node and based on frequencies of the strings whose prefixes are represented by the sub-tree nodes. The deploy weight of a node is indicative of a maximum weight preserved upon filling up at least one prefix, represented by the sub-tree nodes rooted at that node, in a respective bucket. The sub-tree nodes rooted at one node include that one node and the child-nodes of that one node. The values of deploy weights convey the levels of relevancy of the prefixes at the respective nodes for filling up the buckets. The higher valued deploy weights highlight the prefixes that are more relevant for filling up the buckets.

Further, based on the deploy weights associated with the prefixes of the strings, a predefined number of prefixes can be determined or found, from amongst the prefixes represented by the nodes of the prefix tree, for filling up the predefined number of buckets. The predefined number of prefixes are determined through maximization of a total weight preserved by the determined prefixes. The total weight preserved is the weight preserved by the determined prefixes, which can be determined based on the deploy weights of the determined prefixes. The predefined number of prefixes that are determined or found are referred to as Top-prefixes of the string data. Each bucket fills one distinct prefix. Also, the prefixes are determined to cover the prefixes associated with a maximum number of distinct strings. The deploy weights associated with the predefined number of prefixes can then be used to generate a histogram for the string data.

The methods and the systems of the present subject matter enable in capturing distribution of string data and generating histograms with a reduced number of Top-prefixes of strings. By maximizing the total weight preserved by the Top-prefixes, the histogram, in accordance with the present subject matter, captures as much statistical information as possible of the string data. Further, by considering the prefixes of the strings and maximizing the number of prefixes in the Top-prefixes, the coverage of the histogram is over a large (maximum) number of distinct strings in the string data.

In an example, the number of Top-prefixes may be less than the total number of distinct strings in the string data considered for generation of a histogram. Such a histogram of the Top-prefixes facilitates in representing the string data in a substantially compact form, which can be used for data mining, data analytics, approximate query answering, etc. Further, since each of the distinct Top-prefixes is filled in a separate bucket, the number of buckets governs the size of the histogram. The space cost and the time cost of the histogram, in accordance with the subject matter, is based on the number of Top-prefixes or the number of buckets in the histogram. This facilitates in reducing the space cost and the time cost associated with the histograms.

Further, the methods and the systems of the present subject matter enable the generation of histograms both in an offline environment and in an online environment. In an offline environment, the data is static and the complete data set along with the frequency distribution of strings are known in advance. The histograms may be generated for this predetermined static data set in the offline environment. In an online environment, the data is streamed and received, for example, one-by-one in real-time. The frequency distribution of the streamed strings is not known in advance. Thus, histograms may be generated and updated for the streamed data in real-time in the online environment.

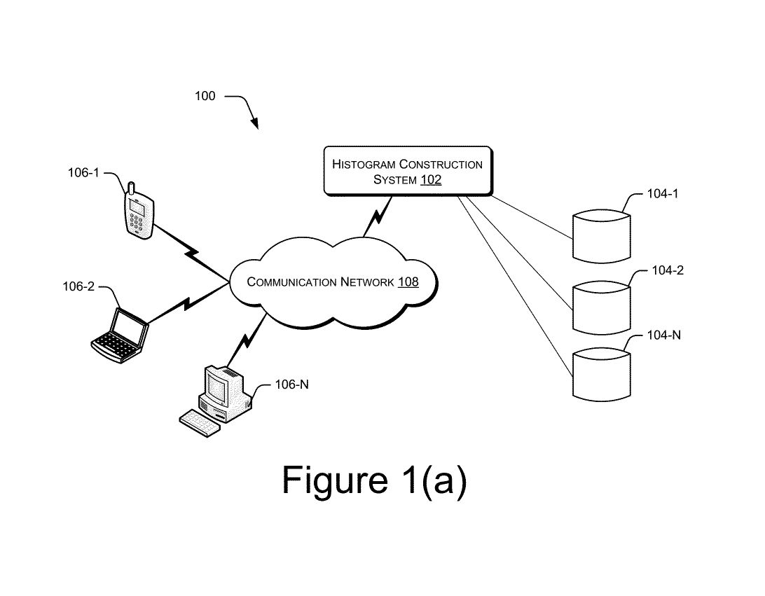

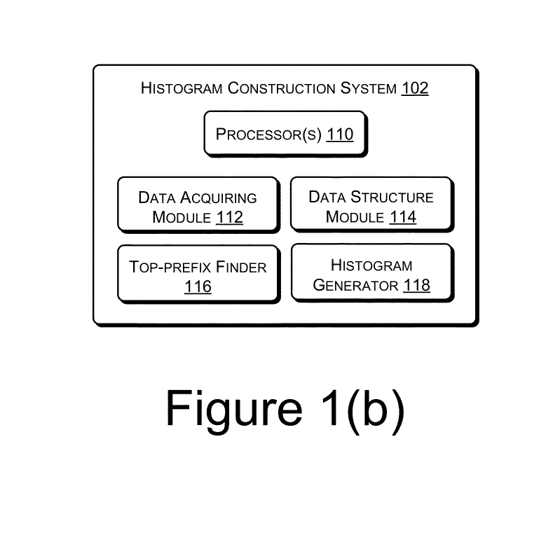

The above methods and systems are further described in conjunction with FIGS. 1 to 9. It should be noted that the description and figures merely illustrate the principles of the present subject matter. It is thus understood that various arrangements can be devised that, although not explicitly described or shown herein, embody the principles of the present subject matter and are included within its spirit and scope. Moreover, all statements herein reciting principles, aspects, and embodiments of the present subject matter, as well as specific examples thereof, are intended to encompass equivalents thereof.

FIG. 1(a) schematically illustrates a system environment 100 implementing a histogram construction system 102, according to an example of the present subject matter. The system environment 100 may be a public environment or a private environment. The histogram construction system 102 may be a machine readable instructions-based implementation or a hardware-based implementation or a combination thereof. The histogram construction system 102 described herein can be implemented in a computing device, such as a server. The histogram construction system 102 in a computing device enables the computing device to generate histograms for string data, in accordance with the present subject matter.

As shown in FIG. 1(a), the histogram construction system 102 is communicatively coupled with a plurality of data sources 104-1, 104-2, . . . , 104-N. The data sources 104-1, 104-2, . . . , 104-N, hereinafter may be collectively referred to as data sources 104, and individually referred to as a data source 104. The data sources 104 may host data, including string data, in static form. In an example, the histogram construction system 102 can access the data sources 104 to receive the string data in static form, which also refers to a fixed data set, for the generation of histograms. Such an environment for generation of histograms refers to an offline environment.

Further, as shown in FIG. 1(a), the histogram construction system 102 is communicatively coupled with a plurality of communication devices 106-1, 106-2, . . . , 106-N through a communication network 108. The communication devices 106-1, 106-2, . . . , 106-N, hereinafter may be collectively referred to as communication devices 106, and individually referred to as a communication device 106. The communication device 106 may include a computer, a laptop, a smart phone, a tablet, and the like. In an example, the histogram construction system 102 can communicate with the communication devices 106 to receive string data streamed online in real-time over the communication network 108, for the generation of histograms. Such an environment for generation of histograms refers to an online environment.

In an example, the communication device 106 may be communicatively coupled to the histogram construction system 102 over the communication network 108 through one or more communication links. The communication links between the communication devices 106 and the histogram construction system 102 are enabled through a desired form of communication, for example, via dial-up modem connections, cable links, and digital subscriber lines (DSL), wireless or satellite links, or any other suitable form of communication.

The communication network 108 may be a wireless network, a wired network, or a combination thereof. The communication network 108 can also be an individual network or a collection of many such individual networks, interconnected with each other and functioning as a single large network, e.g., the Internet or an intranet. The communication network 108 can be implemented as one of the different types of networks, such as intranet, local area network (LAN), wide area network (WAN), the internet, and such. The communication network 108 may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other.

The communication network 108 may also include individual networks, such as but not limited to, Global System for Communication (GSM) network, Universal Telecommunications System (UMTS) network, Long Term Evolution (LTE) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN).

FIG. 1(b) illustrates the histogram construction system 102, according to an implementation of the present subject matter. In an implementation, the histogram construction system 102 includes processor(s) 110. The processor(s) 110 may be implemented as microprocessors, microcomputers, microcontrollers, digital signal processors, central processing units, state machines, logic circuitries, and/or any devices that manipulate signals based on operational instructions. Among other capabilities, the processor(s) 110 fetch and execute computer-readable instructions stored in the memory. The functions of the various elements shown in FIG. 1(b), including any functional blocks labeled as “processor(s)”, may be provided through the use of dedicated hardware as well as hardware capable of executing machine readable instructions.

As shown in FIG. 1(b), the histogram construction system 102 includes a data acquiring module 112, a data structure module 114, a Top-prefix finder 116, and a histogram generator 118. The data acquiring module 112, the data structure module 114, the Top-prefix finder 116, and the histogram generator 118 are coupled to the processor(s) 110.

In an implementation, for the purpose of generation of histograms, the data acquiring module 112 obtains string data comprising strings. The data acquiring module 112 can obtain static string data offline from the data sources 104, and/or can obtain streamed string data online from the communication devices 106. Based on the obtained strings, the data structure module 114 generates a prefix tree for distributing the strings into nodes that represent prefixes of the strings. Based on the nodes in the prefix tree, the Top-prefix finder 116 assigns deploy weights to the nodes. A deploy weight of a node is indicative of a maximum weight preserved upon filling buckets with one or more prefixes represented by the sub-tree nodes rooted at that node, each in a separate bucket.

Based on the deploy weights of the nodes, the Top-prefix finder 116 determines or finds a predefined number of Top-prefixes of the strings for filling up the predefined number of buckets. In an example, the predefined number may be a system defined or a user defined number. This predefined number may be defined based on the number of buckets to be filled in for a histogram, and based on the size of histogram to be constructed. The Top-prefixes are determined from the prefixes in the prefix tree, based on maximization of a total weight preserved by the predefined number of prefixes, where the predefined number of prefixes are associated with a maximum number of distinct strings. Each of the Top-prefixes is filled in a separate bucket, and the deploy weight of the node representing the each Top-prefix is stored in the corresponding bucket.

After determining the Top-prefixes for the strings and filling up the buckets, the histogram generator 118 generates a histogram of the Top-prefixes. The histogram is generated based on the Top-prefixes and the corresponding deploy weights associated with the Top-prefixes in the buckets. The generated histograms can be used for applications, such as data mining, data analytics, and approximate query processing.

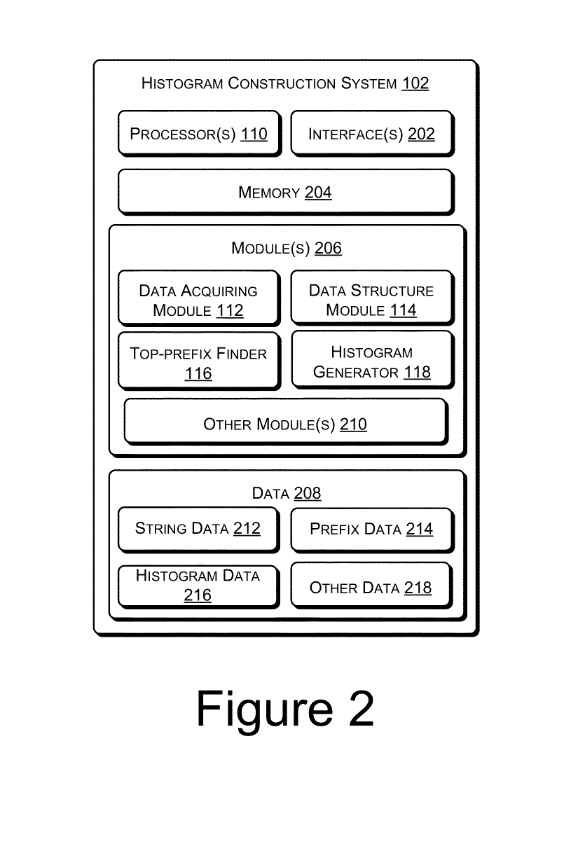

FIG. 2 illustrates the histogram construction system 102, according to an implementation of the present subject matter. The histogram construction system 102 includes the processor(s) 110 and also interface(s) 202. The interface(s) 202 may include a variety of machine readable instruction-based and hardware interfaces that allow the histogram construction system 102 to interact with the data sources 104 and the communication devices 106, as the case may be. Further, the interface(s) 202 may enable the histogram construction system 102 to communicate with other devices, such as network entities, web servers and other external repositories.

Further, the histogram construction system 102 includes memory 204, coupled to the processor(s) 110. The memory 204 may include any computer-readable medium including, for example, volatile memory (e.g., RAM), and/or non-volatile memory (e.g., EPROM, flash memory, NVRAM, memristor, etc.).

Further, the histogram construction system 102 includes module(s) 206 coupled to the processor(s) 110. The module(s) 206, amongst other things, include routines, programs, objects, components, data structures, and the like, which perform particular tasks or implement particular abstract data types. The module(s) 206 further include modules that supplement applications on the histogram construction system 102, for example, modules of an operating system.

The module(s) 206 of the histogram construction system 102 includes the data acquiring module 112, the data structure module 114, the Top-prefix finder 116, the histogram generator 118, and other module(s) 210. The other module(s) 210 may include programs or coded instructions that supplement applications and functions, for example, programs in the operating system of the histogram construction system 102.

Further, the histogram construction system 102 includes data 208. The data 208 serves, amongst other things, as a repository for storing data that may be fetched, processed, received, or generated by the module(s) 206. Although the data 208 is shown internal to the histogram construction system 102, it may be understood that the data 208 can reside in an external repository (not shown in the figure), which may be coupled to the histogram construction system 102. The histogram construction system 102 may communicate with the external repository through the interface(s) 202 to obtain information from the data 208.

In an implementation, the data 208 of the histogram construction system 102 includes string data 212, prefix data 214, histogram data 216, and other data 218. The string data 212 stores the strings obtained by the histogram construction system 102. The prefix data 214 stores the deploy weights of the nodes, and the data in the buckets. The histogram data 216 stores the histograms generated by the histogram construction system 102. The other data 218 comprise data corresponding to other module(s) 210.

As mentioned earlier, the histograms can be generated by the histogram construction system 102 in an online environment and in an offline environment. Before describing the procedures for generation of histograms for string data in online and offline environments, a prefix tree that can be used as a data structure for representing strings in the string data is described. The prefix tree is a Trie data structure that distributes the strings into leaf nodes and branch nodes. A leaf node is a terminal node representing the longest prefix of one of the strings. A branch node represents a longest common prefix of one or more prefixes represented by child-nodes branching out from that branch node.

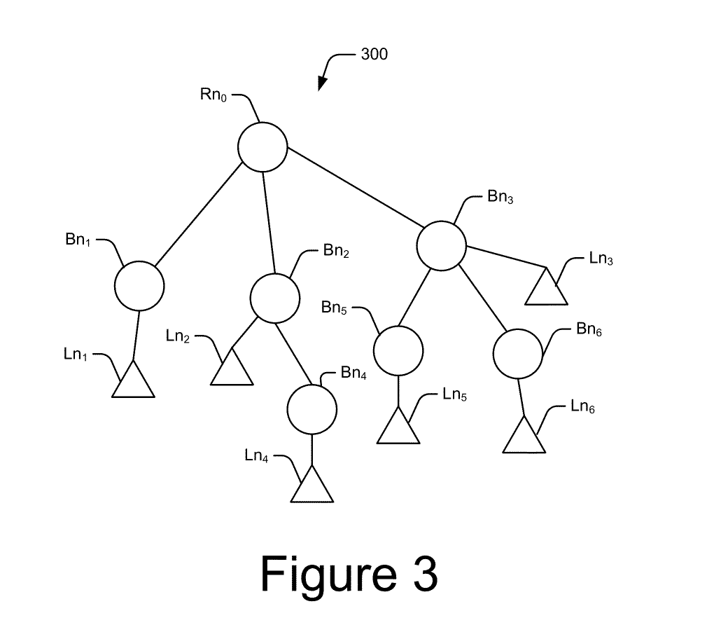

FIG. 3 illustrates a prefix tree 300 for representing string data, according to an example of the present subject matter. The prefix tree 300 is for the string data having the following strings: “address”, “host”, “hostname”, “source”, “sourcecode”, and “sourcename”. As shown, Rn₀ is a root node of the prefix tree 300 from which nodes for the distinct strings branch out. Bn₁ to Bn₆ are the branch nodes and Ln₁ to Ln₆ are the leaf nodes.

The leaf node Ln₁ is a terminal node for the string “address”. The leaf node Ln₁ represents a prefix “address” which is the longest prefix of the string “address”. Similarly, as shown, the leaf nodes Ln₂, Ln₃, Ln₄, Ln₅, and Ln₆ represent the longest prefix as “host”, “source”, “hostname”, “sourcecode”, and “sourcename”, respectively, for the other strings. The branch node Bn₁ represents a prefix “address” which is the longest common prefix of the prefix represented by the leaf node Ln₁. Since only one leaf node Ln₁ is branching out from the branch node Bn₁, the longest common prefix at the branch node Bn₁ is same as the longest prefix at the leaf node Ln₁. Similarly, the branch nodes Bn₄, Bn₅ and Bn₆ represent the longest common prefix as “hostname”, “sourcecode” and “sourcename”, respectively, based on the respective leaf nodes. Further, the branch node Bn₂ represents a prefix “host” which is the longest common prefix of the prefixes represented by the leaf node Ln₂ and the branch node Bn₄. The branch node Bn₃ represents a prefix “source” which is the longest common prefix of the prefixes represented by the leaf node Ln₃ and the branch nodes Bn₅ and Bn₆. Further, the nodes Bn₂, Ln₂, and Bn₄ form a group of sub-tree nodes rooted at the branch node Bn₂. Similarly, the nodes Bn₃, Ln₃, Bn₅, and Bn₆ form a group of sub-tree nodes rooted at the branch node Bn₃. In an example, the prefix tree 300 for the string data may include other internal nodes; however, for the sake of simplicity the root node, the branch nodes and the leaf nodes, as described above, are illustrated.

The description below describes the generation of histograms by the histogram construction system 102 individually in the online environment and in the offline environment.

### Histogram Generation in Online Environment

In an implementation, for the purpose of generation of histograms in an online environment, the data acquiring module 112 obtains strings data online, in real-time, as data streams over the communication network 108. The string data includes strings which are received one-by-one from one or more communication devices 106. Based on the obtained strings, the data structure module 114 generates a prefix tree and iteratively revises the prefix tree to include the strings, as received one-by-one, in the prefix tree. Based on the prefix tree, the Top-prefix finder 116 assigns deploy weights to the nodes, and fills buckets based on the deploy weights. For the purposes of the present subject matter, since one bucket is filled with one distinct prefix, the number of buckets is equal to a predefined number of Top-prefixes to be determined from the prefix tree.

For determining the predefined number of Top-prefixes from the prefix tree, the Top-prefix finder 116 updates prefixes and corresponding deploy weights in a maximum of predefined number of buckets for each revision of the prefix tree. The description below describes the process of assigning of deploy weights and updating of the buckets for determining the Top-prefixes by maximization of total weight preserved by the prefixes in the buckets over a maximum number of distinct strings. Based on the Top-prefixes and the corresponding deploy weights in the buckets, a histogram can be generated by the histogram generator 118.

For the purposes of the description herein, let a string be denoted by s, a bucket be denoted by b, a prefix in a bucket b be denoted by p_{b}, a deploy weight in a bucket b be denoted by w_{b}, and the longest common prefix for two prefixes p_{b} and p_{b}′ be denoted by p_{b}∩p_{b}′. The prefix p_{b} also refers to a prefix represented by a node, and the deploy weight w_{b} also refers to a deploy weight of the node representing the prefix p_{b}. Also, the total number of buckets is equal to the predefined number of Top-prefixes that are to be determined for filling the buckets and generating a histogram. Let the predefined number be denoted by k.

Upon receiving a string s, the data structure module 114 updates the prefix tree to include the string s. The prefix tree may already have a branch with one or more branch nodes and a leaf node for the string s. If not, a new branch with a branch node and a leaf node is created from the root node for including the received string s.

Based on the revision of the prefix tree, the Top-prefix finder 116 compares the string s with the prefixes stored in the buckets to determine if the string s matches with any of the prefixes in the buckets. If the string s matches with a prefix p_{b} in the bucket b, the deploy weight w_{b} in the bucket b is revised. The deploy weight w_{b} is revised based on the frequency of the string s in the obtained string data. For this, the frequency of each string in the string data is maintained. If the received string s is a string already represented in the prefix tree, the frequency of the string s is incremented by 1. If the received string s is a new string, the frequency of string s is set as 1. Based on the frequency, the deploy weight w_{b} at the node representing the prefix p_{b} is revised to make it equal to the frequency of the string s. The revised deploy weight w_{b} is assigned to the node, and the deploy weight w_{b} in the bucket b is replaced by the revised deploy weight w_{b}.

Further, if the string s does not match with any of the prefixes in the buckets, the Top-prefix finder 116 finds an empty bucket from the total of k number of buckets. Upon finding an empty bucket, the longest prefix of the string s, represented by a leaf node, is filled in that empty bucket. The deploy weight equal to the frequency of the string s is assigned to the leaf node representing the longest prefix of the string s. The deploy weight assigned to the leaf node is stored as the deploy weight w_{b} in the bucket b.

Further, if the string s does not match with any of the prefixes in the buckets, and no bucket is empty or unfilled, the Top-prefix finder 116 identifies a bucket pair b, b′ with prefixes p_{b}, p_{b}′ for which a loss weight is minimum. The loss weight is indicative of a loss in weight preserved upon filling one bucket b with the longest common prefix p_{b}∩p_{b}′ and releasing or emptying the bucket b′. For the purposes of the description herein, the loss weight is denoted by lw. For the bucket pair b, b′, the loss weight lw is computed based on equation (1) below:

$$l w ( b , {b}^{′} ) = {w}_{b} ( 1 - \frac{\vert {p}_{b} ⋂ {{p}_{b}}^{′} \vert}{\vert {p}_{b} \vert} ) + {{w}_{b}}^{′} ( 1 - \frac{\vert {p}_{b} ⋂ {{p}_{b}}^{′} \vert}{\vert {{p}_{b}}^{′} \vert} ) , \qquad ( 1 )$$

where w_{b} and w_{b}′ are deploy weights of the prefixes p_{b} and p_{b}′ in the buckets b and b′, respectively, |p_{b}| is the length of prefix p_{b}, |p_{b}| is the length of prefix p_{b}′, |p_{b}∩p_{b}′| is the length of longest common prefix p_{b}∩p_{b}′.

For identifying a bucket pair b, b′ with a minimum loss weight, the loss weights for different pairs of buckets are computed. One with the minimum loss weight is identified for further updating of the buckets. In an example, the loss weight for a bucket pair b, b′ with prefixes p_{b} and p_{b}′ is computed, if the prefix tree has a branch node representing the longest common prefix p_{b}∩p_{b}′.

Further, based on the value of loss weight for the identified pair of buckets, the Top-prefix finder 116 revises or updates the buckets to maximize the total weight preserved by the prefixes in the buckets, and to have the prefixes in the buckets, which are associated with a maximum number of distinct strings. For this, if the loss weight lw for the identified bucket pair b, b′ with prefixes p_{b} and p_{b}′ has a value less than 1, then the bucket b is filled with the longest common prefix p_{b}∩p_{b}′ to replace the prefix p_{b} in the bucket b. For revision of the deploy weight w_{b}, the deploy weight of the branch node representing the longest common prefix p_{b}∩p_{b}′ is computed as a sum of the deploy weights w_{b} and w_{b}′ minus the loss weight lw. This deploy weight is assigned to the branch node representing the longest common prefix p_{b}∩p_{b}′, and replaced as the deploy weight w_{b} in the bucket b. In addition, the other bucket b′ is emptied by removing the prefix p_{b}′ and the corresponding deploy weight w_{b}′, and the longest prefix represented by the leaf node for the string s is filled in the bucket b′. For the deploy weight w_{b}′, the deploy weight of the leaf node representing the longest prefix of the string s is assigned to be equal to the frequency of the string s. Since the frequency of the string s is incremented by 1, the deploy weight w_{b} of the leaf node is increased by 1. This deploy weight of the leaf node is stored as the deploy weight w_{b}′ in the bucket b′.

The deploy weights in all the buckets are indicative of the total weight preserved by the prefixes in the buckets. With the loss weight for a bucket pair b, b′ being less than 1 and by updating the buckets as described above, the total deploy weight in the buckets is reduced by a value less than 1 after the merging the contribution of the prefixes p_{b} and p_{b}′ in the bucket b. The total deploy weight in the buckets is gained by a value 1 by filling the prefix and the deploy weight associated with the string s in the bucket b′. This facilitates in maximizing the total weight preserved by the prefixes in the buckets and filling up the buckets with prefixes associated with a maximum number of strings.

Further, if the loss weight lw for the identified bucket pair b, b′ with prefixes p_{b} and p_{b}′ has a value equal to 1 or more, then the string s is not considered, and the deploy weights in the buckets are reduced by a value 1.

With the revision of deploy weight in the buckets as described above, a deploy weight in one or more buckets may become less than 1. In an implementation, the buckets for which the deploy weights become less than 1 are released or emptied, and made available for filling during the iterative cycle for the next string.

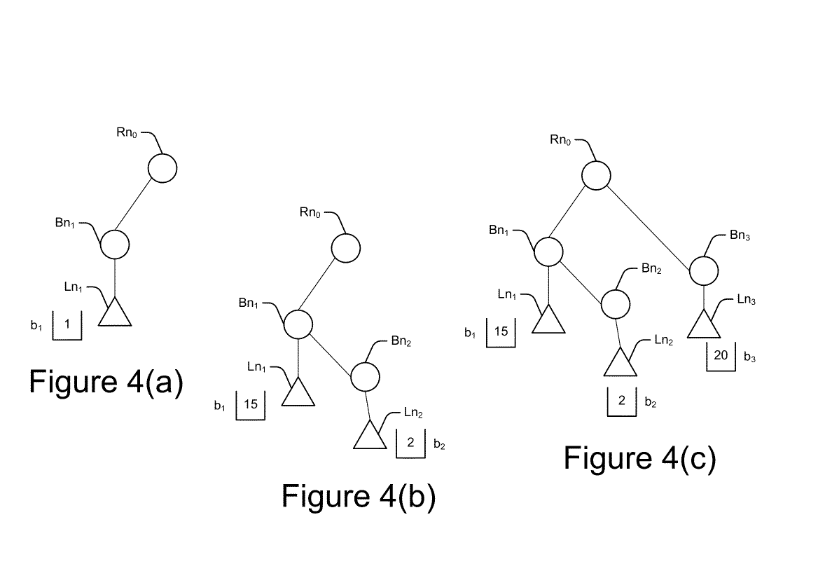

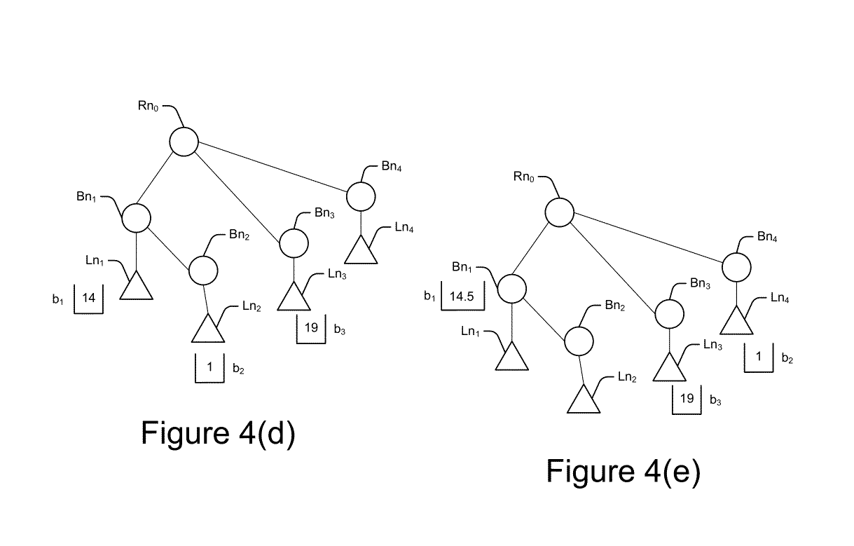

The description below describes the details of generating and revising a prefix tree for the incoming strings, revising and assigning deploy weights at the nodes, and updating buckets for generation of a histogram in an online environment through an illustrative example. Consider a case where the string data, obtained in an online environment, includes four strings: “host”, “hostname”, “address” and “server” with respective frequencies as 15, 2, 20 and 2, and three Top-prefixes are to be determined to fill in a maximum three buckets for generation of a histogram. The strings are received serially, one-by-one, in real-time. FIGS. 4(a), 4(b), 4(c), 4(d), and 4(e) illustrate iterative revisions of a prefix tree for the strings in an online environment, according to an example of the present subject matter.

Initially, the prefix tree only has a root node Rn₀, and all the three buckets are empty. In said example, let's say at first the string “host” is received. The prefix tree is revised to include the string “host”. FIG. 4(a) shows the prefix tree, revised to include the string “host”. The prefix tree, as shown in FIG. 4(a), has a leaf node Ln₁ representing the longest prefix as “host”, and has a branch node Bn₁ representing the longest common prefix also as “host”. As the string “host” is the first string received, the frequency f₁ of the string “host” is set as 1 and maintained for the leaf node Ln₁. Based on the frequency f₁, a deploy weight is assigned to the leaf node Ln₁. The deploy weight for the leaf node Ln₁ is equal to the frequency f₁ at the leaf node Ln₁. Now, since all the buckets are empty, the longest prefix of the string “host”, represented by the leaf node Ln₁, is filled in a first bucket b₁, and the deploy weight at the leaf node Ln₁ is stored as the deploy weight w_{b1} in the first bucket b₁.

After this, let's say the string “host” is again received one-by-one 14 times. Each time, the prefix tree is revised to include the string “host”, the frequency f₁ at the leaf node Ln₁ is incremented by 1, and the deploy weight at the leaf node Ln₁ is also incremented by 1 in accordance with the frequency f₁. With the string “host” matching each time with the prefix stored in the bucket b₁, the deploy weight w_{b1} in the bucket b₁ is revised in accordance with the deploy weight at the leaf node Ln₁. After the iterations, the frequency f₁ becomes 15, the deploy weight at the leaf node Ln₁ becomes 15, and the deploy weight wb1 in the bucket b₁ becomes 15, as shown in FIG. 4(b).

After this, let's say the string “hostname” is received 2 times. Each time, the prefix tree is revised to include the string “hostname”. FIG. 4(b) shows the prefix tree revised to include the string “hostname”. The prefix tree has a branch node Bn₂ representing the longest common prefix as “hostname”, and has a leaf node Ln₂ representing the longest prefix as “hostname”. The branch node Bn₂ branches out from the branch node Bn₁. The branch node Bn₁ now represents the longest common prefix of the strings “host” and “hostname”. When the string “hostname” is received for the first time, the frequency f₂ of the string “hostname” is set as 1 and maintained for the leaf node Ln₂. The deploy weight is assigned to the leaf node Ln₁ based on the frequency f₂. Further, since string “hostname” is not matching with the prefix stored in the bucket b₁, the longest prefix of the string “hostname” is filled in a second bucket b₂, and the deploy weight at the leaf node Ln₂ is stored as the deploy weight w_{b2} in the second bucket b₂. For the next reception of the string “hostname”, the prefix tree is revised to include the string “hostname”, the frequency f₂ at the leaf node Ln₂ is incremented by 1, and the deploy weight at the leaf node Ln₂ is also incremented by 1. With the string “hostname” matching with the prefix in the bucket b₂, the deploy weight wb₂ in the bucket b₂ is revised in accordance with the deploy weight at the leaf node Ln₂. After the iterations, the frequency f₂ becomes 2, the deploy weight at the leaf node Ln₂ becomes 2, and the deploy weight w_{b2} in the bucket b₂ becomes 2, as shown in FIG. 4(b).

After this, let's say the string “address” is received 20 times. After the iterations for the string “address”, the revised prefix tree has another branch node Bn₃ representing the longest common prefix as “address” and has another leaf node Ln₃ representing the longest prefix as “address”, as shown in FIG. 4(c). Also, the frequency f₃ at the leaf node Ln₃ becomes 20, and the deploy weight at the leaf node Ln₃ also become 20. For the first iteration with the string “address”, since the string “address” is not matching with the prefixes stored in the buckets b₁ and b₂, and a third bucket b₃ being empty, the longest prefix of the string “address” is filled in the third bucket b₃. After the iterations, the deploy weight w_{b3} in the bucket b₃ becomes 20, as shown in FIG. 4(c).

After this, let's say the string “server” is received once. The prefix tree is again revised to include the string “server”. The revised prefix tree, as shown in FIG. 4(d), has another leaf node Ln₄ representing the longest prefix as “server”, and has another branch node Bn₄ representing the longest common prefix as “server”. The frequency f₄ of the string “server” is set as 1 and maintained for the leaf node Ln₄. The deploy weight, equal to the frequency f₄, is assigned to the leaf node Ln₄.

Now, for updating the buckets, since the string “server” is not matching with the prefixes in the buckets b₁, b₂ and b₃, and since no more empty buckets are available, a bucket pair is identified for which a loss weight is minimum. As mentioned earlier, the loss weight for those bucket pairs is computed, for which the prefix tree has respective branch nodes representing the longest common prefixes of the prefixes in the respective bucket pairs. As shown in FIG. 4(d), the prefix tree has one branch node Bn₁ representing the longest common prefix of the prefixes in the buckets b₁ and b₂. The loss weight for the bucket pair b₁ and b₂ is computed through equation (1):

lw(b₁,b₂)=15(1−4/4)+2(1−4/8)=1.

Since the value of loss weight for buckets b₁ and b₂ is equal to 1, the string “server” is ignored and the deploy weights w_{b1}, w_{b2}, w_{b3} in the buckets b₁, b₂, b₃ are reduced by 1, as shown in FIG. 4(d). In an example, the branch representing the string “server”, the frequency f₄, and the deploy weight at the leaf node Ln₄, are removed from the prefix tree.

After this, let's say the string “server” is received once again. The revised prefix tree, as shown in FIG. 4(e), again has a leaf node Ln₄ representing the longest prefix as “server”, and has a branch node Bn₄ representing the longest common prefix as “server”. The frequency f₄ of the string “server” is set as 1 and maintained for the leaf node Ln₄. The deploy weight, equal to the frequency f₄, is assigned to the leaf node Ln₄. Now, again for updating the buckets, since the string “server” is not matching with the prefixes in the buckets b₁, b₂ and b₃, and since no more empty buckets are available, a bucket pair is again identified for which a loss weight is minimum. Again, buckets b₁ and b₂ are identified for loss weight computation, and the loss weight for the bucket pair b₁ and b₂ is computed through equation (1):

lw(b₁,b₂)=14(1−4/4)+1(1−4/8)=0.5.

Since the value of loss weight for buckets b₁ and b₂ is 0.5 (less than 1), the bucket b₁ is filled with the longest common prefix represented by the branch node Bn₁. The deploy weight of (14+1−0.5=14.5) is assigned to the branch node Bn₁, and this deploy weight is stored as the deploy weight w_{b1} in the bucket b₁. Also, the prefix “hostname” and the corresponding deploy weight w_{b2} are removed from the bucket b₂. The longest prefix represented by the leaf node Ln₄ is filled in the bucket b₂, and the deploy weight at the leaf node Ln₄ is stored as the deploy weight w_{b2} in the bucket b₂. The prefixes and the deploy weights w_{b1}, w_{b2}, w_{b3} in the buckets b₁, b₂, b₃ are as shown in FIG. 4(e). With this, the total deploy weight of the buckets is reduced by 0.5 due to merging of contributions of the strings “host” and “hostname” in the bucket b₁, and gained by 1 due to filling up of the bucket b₂ with the contribution of the string “server”. Also, with this, the prefixes in the buckets are associated with four distinct strings, instead of three distinct strings as shown in FIGS. 4(c) and 4(d). Further, the prefixes “host”, “address” and “server” are the three Top-prefixes determined for filling up the three buckets, and the deploy weights w_{b1}, w_{b2}, w_{b3} in the buckets b₁, b₂, b₃ can be used for generation of a histogram over the Top-prefixes for the strings.

The space cost associated with the histogram generated in the online environment is O(|k|), as a maximum of k number of buckets are used for filling up with the k number of Top-prefixes for generation of the histogram. Further, the time cost associated with the histogram generated in the online environment for each iterative revision of the prefix tree based on a new string is O(|k|), as each update of a maximum of k number of buckets takes the time of the order of |k|. The total time cost associated with the histogram depends on the number of strings received in the online environment.

Although the example of generation of histogram in the online environment is described for a few strings; the histogram construction system 102 can perform the same procedure with a substantially large number of strings to determine a predefined number of Top-prefixes and generate histograms based on the top-prefixes for the strings.

### Histogram Generation in Offline Environment

In an implementation, for the purpose of generation of histograms in an offline environment, the data acquiring module 112 obtains string data in an offline manner from one or more data sources 104. The string data includes static strings with a predefined frequency distribution. The predefined frequency distribution has a frequency of each of the static strings in the string data. In an implementation, the frequencies of the string can be obtained from the respective data sources 104, or can be determined by the data acquiring module 112 after obtaining the static strings.

The description below describes the process of generating a prefix tree, assigning deploy weights to the nodes, and determining a predefined number of Top-prefixes by maximization of total weight preserved by the prefixes in the buckets over a maximum number of distinct strings. For the purposes of the description herein, let a string be denoted by s, a frequency of string s be denoted by f(s), a node of prefix tree be denoted by d, a fractional weight of node d be denoted by fwd, and a prefix represented by node d be denoted by p_{d}. Also, the total number of buckets is equal to the predefined number of Top-prefixes that are to be determined for filling the buckets and generating a histogram. Let the predefined number be denoted by k.

Since, in the offline environment, the string data set with all the strings is known for generation of a histogram, the data structure module 114 generates a prefix tree for all the distinct strings in the string data set. For determining the predefined number of Top-prefixes from the prefix tree, in an implementation, the Top-prefix finder 116 performs a breadth first search to traverse the prefix tree and determine a reverse traverse order for the nodes. The reverse traverse order captures a sequential order of nodes from the bottom of the prefix tree, i.e., from the leaf nodes, towards the top of the prefix tree, i.e., towards the root node.

After determining the reverse traverse order, the Top-prefix finder 116 computes a fractional weight for each of the nodes in the prefix tree in accordance with the reverse traverse order. The fractional weight of a j^{th} leaf node is computed based on equation (2) below:

fw_{dj}=f(sⱼ), (2)

where f(sⱼ) is the frequency of the j^{th} string whose longest prefix p_{dj} is represented by the j^{th} leaf node. The fractional weight of a j^{th} branch node is computed based on equation (3) below:

$$f {w}_{d j} = {\sum }_{i = 1}^{m} f {w}_{d i} \times \frac{\vert {p}_{d j} \vert}{\vert {p}_{d i} \vert} \qquad ( 3 )$$

where m is equal to the number of child-nodes of the j^{th} branch node, fwd, is the fractional weight of the i^{th} child-node of the j^{th} branch node, |p_{d}_{ⱼ}| is a length of prefix pdⱼ represented by the j^{th} branch node, and |p_{di}| is a length of prefix p_{di} represented by the i^{th} child-node of the j^{th} branch node.

Since the fractional weights are computed in accordance with the reverse traverse order, the fractional weights of child-nodes are known for computing the fractional weight of a branch node. The fractional weight of a leaf node is a measure of a weight preserved by the leaf node with respect to the frequency of the string associated with the leaf node. And, the fractional weight of a branch node is a measure of a fractional weight preserved by the branch node depending on contributions of its child-nodes for weight preservation. The fractional contributions for a branch node are governed by the ratios of the length of the prefix at the branch node and the length of the prefix at the respective child-nodes.

After computing the fractional weights for all the nodes, the Top-prefix finder 116 assigns deploy weights to the nodes. For a node d, a number of deploy weights are computed and assigned to the node d depending on the number of buckets, from 1 to at most k buckets, which can be possibly filled by the prefixes at the sub-tree nodes rooted at the node d and by the prefixes at further sub-tree nodes rooted at child-nodes of the node d. For the purposes of the description herein, let the deploy weight assigned to the node d be denoted by dw_{d}. Let dw_{d}¹, dw_{d}², . . . , dw_{d}^{k} denote the deploy weight of the node d when 1, 2, . . . , k buckets are filled with 1, 2, . . . , k prefixes represented by the sub-tree nodes rooted at the node d and by the further sub-tree nodes rooted at the child-nodes of the node d. The deploy weight dw_{d}^{t} is indicative of a maximum weight preserved upon filling t number of buckets with t number of prefixes represented by the sub-tree nodes rooted at the node d and by the further sub-tree nodes rooted at the child-nodes of the node d.

In addition, for each node d and against each deploy weight dw_{d}^{t}, the combination of sub-tree nodes representing the prefixes, for which the weight preserved is maximum, is determined as an arrangement set. Let the arrangement set for the deploy weight dw_{d}^{t} be denoted by {arr_{d}^{t}}. The arrangement set {arr_{d}^{t}} is indicative of the sub-tree nodes at node d whose prefixes if filled in the t number of buckets will result in the maximum weight preservation.

In addition, for each node d and against each deploy weight dw_{d}^{t}, depending on the {arr_{d}^{t}}, a leak weight is computed. Let the leak weight for the deploy weight dw_{d}^{t} and the arrangement set {arr_{d}^{t}} be denoted by lw_{d}^{t}. The leak weight lw_{d}^{t} is indicative of leaking information across the node d when t number of buckets are filled. The leak weight lw_{d}^{t} is a measure of total information of the sub-tree nodes at the node d minus the deploy weight dw_{d}^{t}.

The description below describes the computation and determination of the deploy weights dw_{d}, the leak weights lw_{d} and the arrangement sets {arr_{d}} which can be followed for each of the node d. The deploy weights dw_{d}, the leak weights lw_{d} and the arrangement sets {arr_{d}} are computed and determined for the nodes in accordance with the reverse traverse order. With this, the deploy weights dw_{d} and the leak weights lw_{d} of child-nodes are known for computing deploy weights dw_{d} and the leak weights lw_{d} of a branch node.

For each leaf node, since there is no branch node only one bucket (t=1) can be filled in by the prefix represented by the lead node. The deploy weight dw_{d} for the j^{th} leaf node is computed based on equation (4) below:

dw_{dj}¹=fw_{dj}, (4)

where fw_{dj} is the fractional weight for the j^{th} leaf node. The leak weight lw_{dj} for the j^{th} leaf node is zero, and the corresponding arrangement set {arr_{dj}¹} refers to the leaf node.

For a node d other than the leaf nodes, one to at most k buckets (t=1 to k) can possibly be filled by the prefixes at the sub-tree branch nodes rooted at that node d. The number of buckets that can be filled depends on the number of sub-tree child nodes rooted at that node d. Let's say the j^{th} node dⱼ in the prefix tree has q number of child branch nodes in the sub-tree rooted at the node dj. Then the number of sub-tree branch nodes rooted at the node dⱼ is equal to q+1.

For the j^{th} node dⱼ, with one bucket being possibly filled, i.e., t=1, the deploy weight dw_{dj}¹ is computed based on equation (5) below:

dw_{dj}¹=max{fw_{dj},dw_{di}¹: i=1 to q}, (5)

where fw_{dj} is the fractional weight for the node dⱼ, and dw_{di}′ is the deploy weight of the i^{th} child branch node of the node dⱼ for one filled bucket. The function max { } means that the deploy weight dw_{w}_{_{dj}}¹′ takes a value which maximum from fw_{dj} and dw_{di}¹s.

Further, for t=1, the arrangement set {arr_{dj}¹} refers to a node, from the sub-tree branch nodes rooted at the node dⱼ, whose value is taken as the deploy weight dw_{dj}¹. Further, for t=1, the leak weight lw_{dj}¹ is computed based on equation (6) below:

$$l {w}_{d j}^{1} = \{ \begin{matrix}0 & if \{ {arr}_{d j}^{1} \} includes the node {d}_{j} \\ {\sum }_{i = 1 to q} l {w}_{d i}^{0} \times \frac{\vert {p}_{d j} \vert}{\vert {p}_{d i} \vert} & if \{ {arr}_{d j}^{1} \} does not include the node {d}_{j}\end{matrix} \} , \qquad ( 6 )$$

where lw_{dj}⁰=fw_{di}, |p_{dj}| is the length of the prefix at the node dⱼ, and |p_{di}| is the length of the prefix at the i^{th} child branch node of the node dⱼ.

Further, for the j^{th} node dⱼ, with possible number of buckets filled being equal to the number of sub-tree branch nodes of the node dⱼ, i.e., t=q, the deploy weight dw_{dj}^{q} is computed based on equation (7) below:

dw_{dj}^{q}=f(sⱼ)+f(sⱼ)+Σ_{i=1toq}f(sᵢ), (7)

where f(sⱼ) is frequency of the string sⱼ whose prefix is represented by the node dⱼ, and f(sᵢ) is frequency of the string sᵢ whose prefix is represented by the i^{th} child branch node of the node dⱼ.

Further, for t=k, the arrangement set {arr_{dj}^{k}} refers to the sub-tree branch nodes rooted at the node dⱼ. Further, for t=k, the leak weight lw_{dj}^{k} is zero.

Further, for the j^{th} node dⱼ, with possible number of buckets filled being more than one and less than the number of sub-tree branch nodes at the node dⱼ, i.e., 1<t≦k<q+1, and for computing the deploy weight dw_{dj}^{t}, a term “deployment factor” denoted by x is defined for the node dⱼ. The deployment factor xᵢ denotes a number of buckets that can be filled by or deployed on the sub-tree branch nodes rooted on the i^{th} child branch node of the node dⱼ. With q child branch nodes of the node dⱼ, x₁ refers to the number of buckets that can be filled by the sub-tree branch nodes rooted on the first child branch node, x₂ refers to the number of buckets that can be filled by the sub-tree branch nodes rooted on the second child branch node, and so on. Here x₀ refers to the number of buckets that can be filled by the node dⱼ. Thus, x₀ can be either 0 or 1 for a bucket filled by the node dⱼ and not filled by the node dⱼ, respectively. For various possible values of x₀, x₁, x₂, . . . , x_{q} for the node dⱼ, each deployment factor set {X} is defined as {x₀, x₁, x₂, . . . , x_{q}}.

Now, for computing the deploy weight dw_{dj}^{t}, all possible combination of deployment factors x are enumerated in the deployment factor sets {Xₜ}, such that Σxi=t, where i=0 to q. With this, the deploy weight dw_{dj}^{t} is computed based on equation (8) below:

$$d {w}_{dj}^{t} = max \{ \begin{matrix}{max}_{\{ Xt \}} \{ {\sum }_{i = 1 to q} ( d {w}_{d i}^{x i} + \frac{\vert {p}_{d j} \vert}{\vert {p}_{d i} \vert} \times l {w}_{d i}^{x i} ) \} & when {x}_{0} = 1 \\ {max}_{\{ Xt \}} \{ {\sum }_{i = 1 to q} ( d {w}_{d i}^{x i} ) \} & when {x}_{0} = 0\end{matrix} \} \qquad ( 8 )$$

where dw_{di}^{xi} is the deploy weight of the i^{th} child branch node at the node dⱼ, lw_{di}^{xi} is the leak weight of the i^{th} child branch node at the node dⱼ, |p_{dj}| is length of the prefix at the node dⱼ, and |p_{di}| is length of the prefix at the i^{th} child branch node of the node dⱼ. Here lw_{di}⁰=fw_{di}, and max_{{Xt}}{ } means a value which is maximum over all the enumerated deployment factor sets {Xₜ} for the node dⱼ.

Further, the arrangement set {arr_{dj}^{t}} is determined based on the deployment factors in the deployment factor set {Xₜ} which decide the deploy weight dw_{dj}^{t}. Based on the determined arrangement set {arr_{dj}^{t}}, the leak weight lw_{dj}^{t} is computed through equation (9) below:

$$l {w}_{d j}^{t} = \{ \begin{matrix}0 & when {x}_{0} = 1 \\ {\sum }_{i = 1 to q} ( \frac{\vert {p}_{d j} \vert}{\vert {p}_{d i} \vert} \times l {w}_{d i}^{x i} ) & when {x}_{0} = 0\end{matrix} \} . \qquad ( 9 )$$

Based on equations (8) and (9), the deploy weight dw_{dj}^{t} and the leak weight lw_{dj}^{t} are computed, and the arrangement set {arr_{dj}^{t}} is determined with t=2, 3, and so on, up to t≦k<q+1 for each node dⱼ. These computations enable in identifying and arriving at the combinations of nodes in each branch rooted at the root node of the prefix tree, for which the weight preserved is maximum when 1 to at most k number of buckets are filled by the prefixes at those combinations of nodes.

After, determining the deploy weights, the leak weights, and the arrangement sets for the leaf nodes and the branch nodes of the prefix tree, the deploy weights and the arrangement sets are computed and determined for the root node of the prefix tree in the manner as described above using equations (5), (7) and (8). For this, the node d is considered as the root node in equations (5), (7) and (8).

Based on the computations for the root node, the arrangement set {arr_{Rn0}^{k}} captures and refers to those k nodes whose prefixes when filled in the k buckets preserve the maximum weight. The prefixes represented by such k nodes are the Top-prefixes that can be filled in the k buckets. Subsequent to this, the histogram generator 118 generates a histogram for the strings received in the offline environment based on the deploy weights of those k nodes identified from the arrangement set {arr_{Rn0}^{k}}.

In an implementation, for each node d, the deploy weights dw_{d}, the leak weights lw_{d} and the arrangement sets {arr_{d}ⁱ} are stored as elements of an array. Let the array for the node d be denoted by V_{d}.

The description below describes the details of generating a prefix tree for the static strings, assigning deploy weights to nodes, and determining a predefined number of Top-prefixes to fill in the predefined number of buckets for generation of a histogram in an offline environment through an illustrative example. Consider a case where the string data, obtained in an offline environment, includes strings s as listed in Table 1 below. Table 1 also lists frequencies f(s) for the received strings. Let's say three Top-prefixes are to be determined to fill a maximum of three buckets, i.e., maximum value of k is 3, for generation of a histogram.

TABLE 1

| String s | Frequency f(s) |
|---|---|
| address | 5 |
| code | 7 |
| server | 5 |
| serverMN | 4 |
| host | 10 |
| hostFG | 9 |
| hostXY | 5 |
| hostname | 8 |
| hostcodeTU | 10 |
| hostnameABCD | 10 |

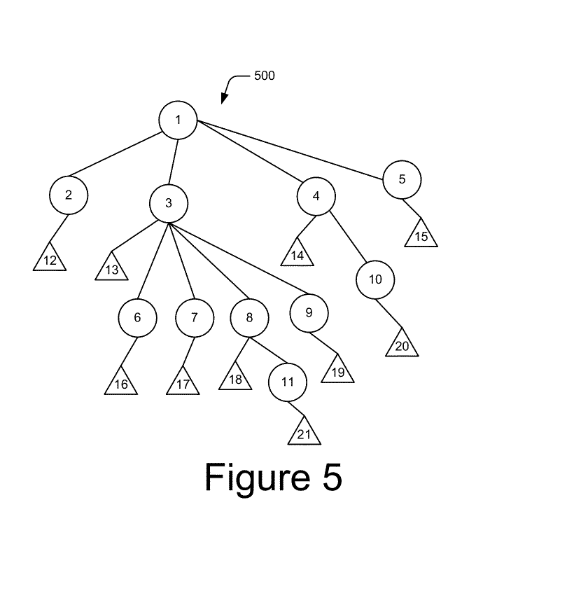

FIG. 5 illustrates a prefix tree for the strings in an offline environment, according to an example of the present subject matter. The prefix tree, as shown, has a root node, multiple branch nodes and multiple leaf nodes based on the strings. Initially, the prefix tree is traversed by performing a breadth first search, and a reverse traverse order for the nodes is determined. The nodes in the prefix tree are sequentially numbered in accordance with the reverse traverse order, as shown in FIG. 5. For the purpose of the description herein, a node is denoted as dⱼ where j is the node number of that node. Table 2 enlists the node number according to the reverse traverse order, and indicates the prefix p_{d} represented by the corresponding node d. The node d₁ is the root node, the nodes d₂, d₃, d₄, d₅, d₆, d₇, d₈, d₉, d₁₀, and d₁₁ are the branch nodes, and the nodes d₁₂, d₁₃, d₁₄, d₁₅, d₁₆, d₁₇, d₁₈, d₁₉, d₂₀, and d₂₁ are the leaf nodes.

TABLE 2

| | Node | | |
|---|---|---|---|
| Node | Repre- | | Fractional |
| Number | sentation | Prefix p_{d} | Weight fw_{d} |
| 21 | d₂₁ | hostnameABCD | 10 |
| 20 | d₂₀ | serverMN | 4 |
| 19 | d₁₉ | hostcodeTU | 10 |
| 18 | d₁₈ | hostname | 8 |
| 17 | d₁₇ | hostXY | 5 |
| 16 | d₁₆ | hostFG | 9 |
| 15 | d₁₅ | code | 7 |
| 14 | d₁₄ | server | 5 |
| 13 | d₁₃ | host | 10 |
| 12 | d₁₂ | address | 5 |
| 11 | d₁₁ | hostnameABCD | 10 |
| 10 | d₁₀ | serverMN | 4 |
| 9 | d₉ | hostcodeTU | 10 |
| 8 | d₈ | hostname | 44/3 |
| 7 | d₇ | hostXY | 5 |
| 6 | d₆ | hostFG | 9 |
| 5 | d₅ | code | 7 |
| 4 | d₄ | server | 8 |
| 3 | d₃ | host | 92/3 |
| 2 | d₂ | address | 5 |
| 1 | d₁ | — | — |

After this, in accordance with the reverse traverse order, a fraction weight fwd of each of the nodes is computed. The fractional weight fwd of the leaf nodes is computed using equation (2) and the fractional weight fwd of the branch nodes is computed using equation (3). The values of fractional weights of the nodes are listed in Table 2. Some example computations of the fractional weights are illustrated below:

$$For node {d}_{11} \text{:} f {w}_{d 11} = f {w}_{d 21} \times \frac{\vert hostnameABCD \vert}{\vert hostnameABCD \vert} = 10 \times \frac{12}{12} = 10 , \\ For node {d}_{4} \text{:} f {w}_{d 4} = f {w}_{d 14} \times \frac{6}{6} + f {w}_{d 10} \times \frac{6}{8} = 5 + 3 = 8 , and$$

$$For node {d}_{3} \text{:} f {w}_{d 3} = f {w}_{d 13} \times \frac{4}{4} + f {w}_{d 6} \times \frac{4}{6} + f {w}_{d 7} \times \frac{4}{6} + f {w}_{d 8} \times \frac{4}{8} + f {w}_{d 9} \times \frac{4}{10}$$

$$f {w}_{d 3} = \frac{92}{3} .$$

After computing the fractional weights fwd for all the nodes, the deploy weights dw_{d}^{t}, the leak weights lw_{d}^{t}, and the arrangement sets {arr_{d}^{t}} are computed and/or determined for all the nodes, in accordance with the reverse traverse order. The computations and determinations are carried out in a manner as described earlier. In an example, for each node d, the deploy weights dw_{d}^{t}, the leak weights lw_{d}^{t}, and the arrangement sets {arr_{d}^{t}} are stored in an array V_{d} with at most k cells, where t^{th} cell of the array V_{d} is {V_{d}^{t}}={dw_{d}^{t}, lw_{d}^{t}, {arr_{d}^{t}}}. For a node d, t can take values from 1≦t≦k<q+1, where q is the number of child branch nodes at the node d, and q+1 refers to the number of sub-tree branch nodes rooted at the node d.

Table 3 illustrates values of the deploy weights, the leak weights and the arrangement sets for the leaf nodes. Since only one bucket can be filled by the prefix represented by a leaf node, the value of t is equal to 1 and the array V_{d} has one cell for each leaf node. The value of dw_{d}¹ for each leaf node is computed through equation (4).

TABLE 3

| Node | | |
|---|---|---|
| Repre- | | |
| sentation | Array Cell Representation {V_{d}} | Array Cell Values |
| d₂₁ | {V_{d21}¹} = {dw_{d21}¹, lw_{d21}¹, {arr_{d21}¹}} | {10, 0, {d₂₁}} |
| d₂₀ | {V_{d20}¹} = {dw_{d20}¹, lw_{d20}¹, {arr_{d20}¹}} | {4, 0, {d₂₀}} |
| d₁₉ | {V_{d19}¹} = {dw_{d19}¹, lw_{d19}¹, {arr_{d19}¹}} | {10, 0, {d₁₉}} |
| d₁₈ | {V_{d18}¹} = {dw_{d18}¹, lw_{d18}¹, {arr_{d18}¹}} | {8, 0, {d₁₈}} |
| d₁₇ | {V_{d17}¹} = {dw_{d17}¹, lw_{d17}¹, {arr_{d17}¹}} | {5, 0, {d₁₇}} |
| d₁₆ | {V_{d16}¹} = {dw_{d16}¹, lw_{d16}¹, {arr_{d16}¹}} | {9, 0, {d₁₆}} |
| d₁₅ | {V_{d15}¹} = {dw_{d15}¹, lw_{d15}¹, {arr_{d15}¹}} | {7, 0, {d₁₅}} |
| d₁₄ | {V_{d14}¹} = {dw_{d14}¹, lw_{d14}¹, {arr_{d14}¹}} | {5, 0, {d₁₄}} |
| d₁₃ | {V_{d13}¹} = {dw_{d13}¹, lw_{d13}¹, {arr_{d13}¹}} | {10, 0, {d₁₃}} |
| d₁₂ | {V_{d12}¹} = {dw_{d12}¹, lw_{d12}¹, {arr_{d12}¹}} | {5, 0, {d₁₂}} |

Table 4 illustrates values of the deploy weights, the leak weights and the arrangement sets for the branch nodes. For the nodes d₁₁, d₁₀, d₉, d₇, d₆, d₅ and d₂, only one bucket can possibly be filled by the prefix at the respective nodes. Thus, t is equal to 1, and the corresponding array V_{d} has one cell. For the node d₄, one or two buckets can possibly be filled by the prefixes at the sub-tree branch nodes rooted at the node d₄. Thus, t can be equal to 1 or 2, and the array V_{d4} has 2 cells, {V_{d4}¹} and {V_{d4}²}. Similarly, for node d₈, t can be equal to 1 or 2, and the array V_{d8} has 2 cells, {V_{d8}¹} and {V_{d8}²}. The values of deploy weights dwelt and leak weights lw_{d}^{t} for the branch nodes are computed through equations (5) to (9).

TABLE 4

| Node | | |
|---|---|---|
| Repre- | | |
| sentation | Array Cell Representation {V_{d}} | Array Cell Values |
| d₁₁ | {V_{d11}¹} = {dw_{d11}¹, lw_{d11}¹, {arr_{d11}¹}} | {10, 0, {d₁₁}} |
| d₁₀ | {V_{d10}¹} = {dw_{d10}¹, lw_{d10}¹, {arr_{d10}¹}} | {4, 0, {d₁₀}} |
| d₉ | {V_{d9}¹} = {dw_{d9}¹, lw_{d9}¹, {arr_{d9}¹}} | {10, 0, {d₉}} |
| d₈ | {V_{d8}¹} = {dw_{d8}¹, lw_{d8}¹, {arr_{d8}¹}} | {44/3, 0, {d₈}} |
| | {V_{d8}²} = {dw_{d8}², lw_{d8}², {arr_{d8}²}} | {18, 0, {d₈, d₁₁}} |
| d₇ | {V_{d7}¹} = {dw_{d7}¹, lw_{d7}¹, {arr_{d7}¹}} | {5, 0, {d₇}} |
| d₆ | {V_{d6}¹} = {dw_{d6}¹, lw_{d6}¹, {arr_{d6}¹}} | {9, 0, {d₆}} |
| d₅ | {V_{d5}¹} = {dw_{d5}¹, lw_{d5}¹, {arr_{d5}¹}} | {7, 0, {d₅}} |
| d₄ | {V_{d4}¹} = {dw_{d4}¹, lw_{d4}¹, {arr_{d4}¹}} | {8, 0, {d₄}} |
| | {V_{d4}²} = {dw_{d4}², lw_{d4}², {arr_{d4}²}} | {9, 0, {d₄, d₁₀}} |
| d₃ | {V_{d3}¹} = {dw_{d3}¹, lw_{d3}¹, {arr_{d3}¹}} | {92/3, 0, {d₃}} |
| | {V_{d3}²} = {dw_{d3}², lw_{d3}², {arr_{d3}²}} | {28, 0, {d₃, d₈}} |
| | {V_{d3}¹} = {dw_{d3}³, lw_{d3}³, {arr_{d3}³}} | {102/3, 0, |
| | | {d₃, d₈, d₉}} |
| d₂ | {V_{d2}¹} = {dw_{d2}¹, lw_{d2}¹, {arr_{d2}¹}} | {5, 0, {d₂}} |

Some example computations of the deploy weights, the leak weights, and the arrangement sets are illustrated below:

For the node d₈, with t=1:

$$d {w}_{d 8}^{1} = max \{ f {w}_{d 8} , d {w}_{d 11}^{1} \} = max \{ \frac{44}{3} , 10 \} = \frac{44}{3} ,$$

lw_{d8}¹=0,

{arr_{d8}¹}={d₈}.

For the node d₈, with t=2:

dw_{d8}²=8+10=18,

lw_{d8}²=0,

{arr_{d8}²}={d₈,d₁₁}.

For the node d₃, with t=1:

$$d {w}_{d 3}^{1} = max \{ f {w}_{d 3} , d {w}_{d 6}^{1} , d {w}_{d 7}^{1} , d {w}_{d 8}^{1} , d {w}_{d 9}^{1} \} = max \{ \frac{92}{3} , 9 , 5 , \frac{44}{3} , 10 \} = \frac{92}{3} , \\ l {w}_{d 3}^{1} = 0 , \\ \{ {arr}_{d 3}^{1} \} = \{ {d}_{3} \} .$$

For the node d₃, with t=2, the possible deployment factor sets {X₂} are shown in Table 5. The node d₃ has four child branch nodes d₆, d₇, d₈ and d₉. The deploy weight dw_{d8}² is computed using equation (8) over all the possible deployment factor sets {X₂}. The deploy weight dw_{d8}² takes the value corresponding to the deployment factor set {1, 0, 0, 1, 0}. Thus, for the node d₃:

$$d {w}_{d 3}^{2} = \frac{\vert {p}_{d 3} \vert}{\vert {p}_{d 6} \vert} \times l {w}_{d 6}^{0} + \frac{\vert {p}_{d 3} \vert}{\vert {p}_{d 7} \vert} \times l {w}_{d 7}^{0} + d {w}_{d 8}^{1} + \frac{\vert {p}_{d 3} \vert}{\vert {p}_{d 9} \vert} \times l {w}_{d 9}^{0} , \\ d {w}_{d 3}^{2} = \frac{4}{6} \times 9 + \frac{4}{6} \times 5 + \frac{44}{3} + \frac{4}{10} \times 10 = 28 , \\ l {w}_{d 3}^{2} = 0 , \\ \{ {arr}_{d 3}^{2} \} = \{ {d}_{3} , {d}_{8} \} .$$

TABLE 5

| Sub-tree branch nodes at node d₃ | d₃, d₆, d₇, d₈, d₉ |
|---|---|
| → | |
| Deployment factor set (X₂} | {x₀, x₁, x₂, x₃, x₄} |
| → | |
| Possible deployment factor sets | {1, 1, 0, 0, 0} |
| → | {1, 0, 1, 0, 0} |
| | {1, 0, 0, 1, 0} |
| | {1, 0, 0, 0, 1} |
| | {0, 1, 1, 0, 0} |
| | {0, 1, 0, 1, 0} |
| | {0, 1, 0, 0, 1} |
| | {0, 0, 1, 1, 0} |
| | {0, 0, 1, 0, 1} |
| | {0, 0, 0, 1, 1} |
| | {0, 0, 0, 2, 0} |

After this, the deploy weights and the arrangement sets are computed and determined for the root node of the prefix tree using equations (5), (7), and (8). For the root node, with t=1: dw_{Rn0}¹=92/3 and {arr_{Rn0}¹}={d₃}. With t=2: dw_{Rn0}²=116/3 and {arr_{Rn0}²}={d₃, d₄}. And, with t=3: dw_{Rn0}³=137/3 and {arr_{Rn0}³}={d₃, d₄, d₅}. Based on the computations for the root node, the nodes d₃, d₄ and d₅ as indicated in the arrangement set {arr_{Rn0}³} the three nodes whose prefixes when filled in three buckets preserve the maximum weight. Thus, the prefixes “host”, “server” and “code” represented by the nodes d₃, d₄, and d₅ are the three Top-prefixes determined for filling up the three buckets, and the deploy weights associated with these nodes are stored in the buckets, which can be used for generation of a histogram for the strings.

The space cost associated with the histogram generated in the offline environment is O(|D·k·f|), as D number of distinct strings are represented by the D number of leaf nodes, and a maximum of k number of buckets are used for filling up with the k number of prefixes. Here, f denotes the maximum fan-out of the prefix tree, which is indicative of the maximum number of distinct characters that can be a part of a string. Further, the time cost associated with the histogram generated in the offline environment is O(|D·k·k^{g}|), as a D number of leaf nodes is parsed to fill a k number of buckets, and, for one node, a maximum of k number buckets are distributed to a g number of child-nodes of that node.

Although the example of generation of histogram in the offline environment is described for a few strings; the histogram construction system 102 can perform the same procedure with a substantially large number of strings to determine a predefined number of Top-prefixes and generate histograms based on the top-prefixes for the strings.

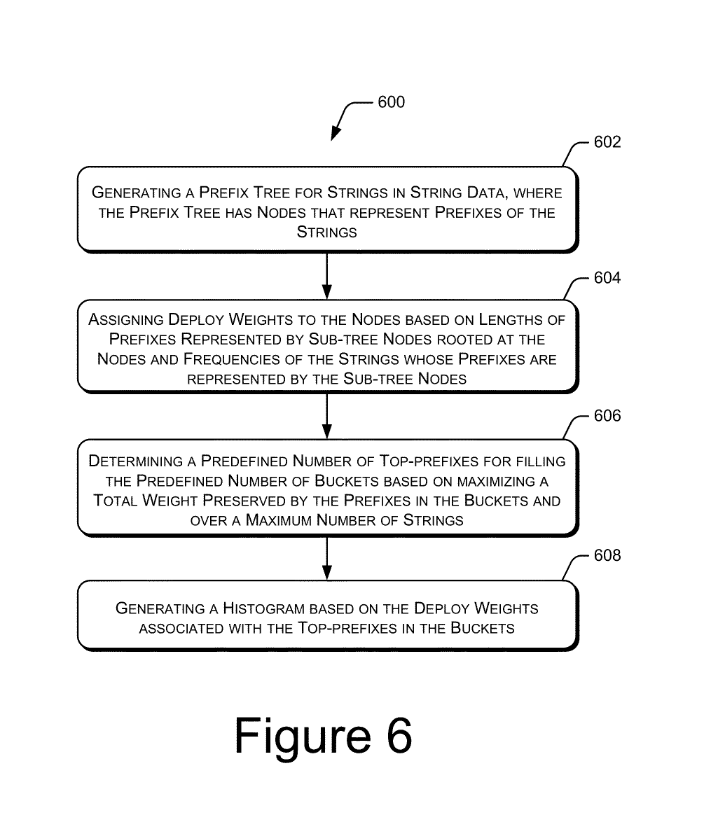

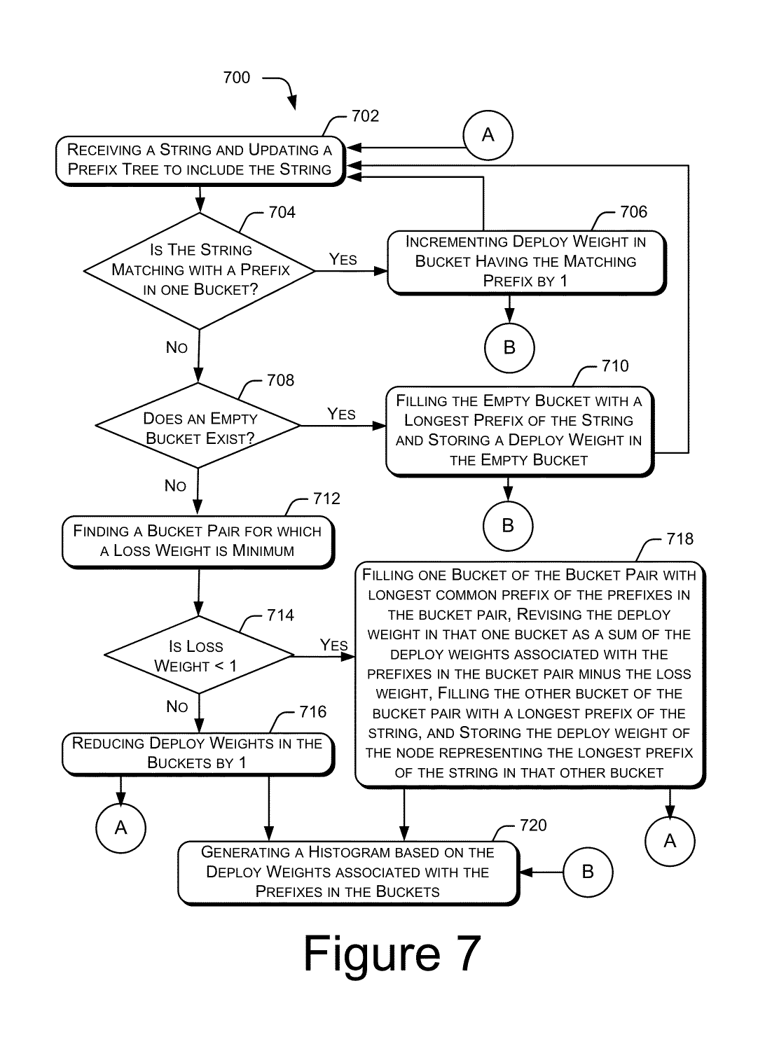

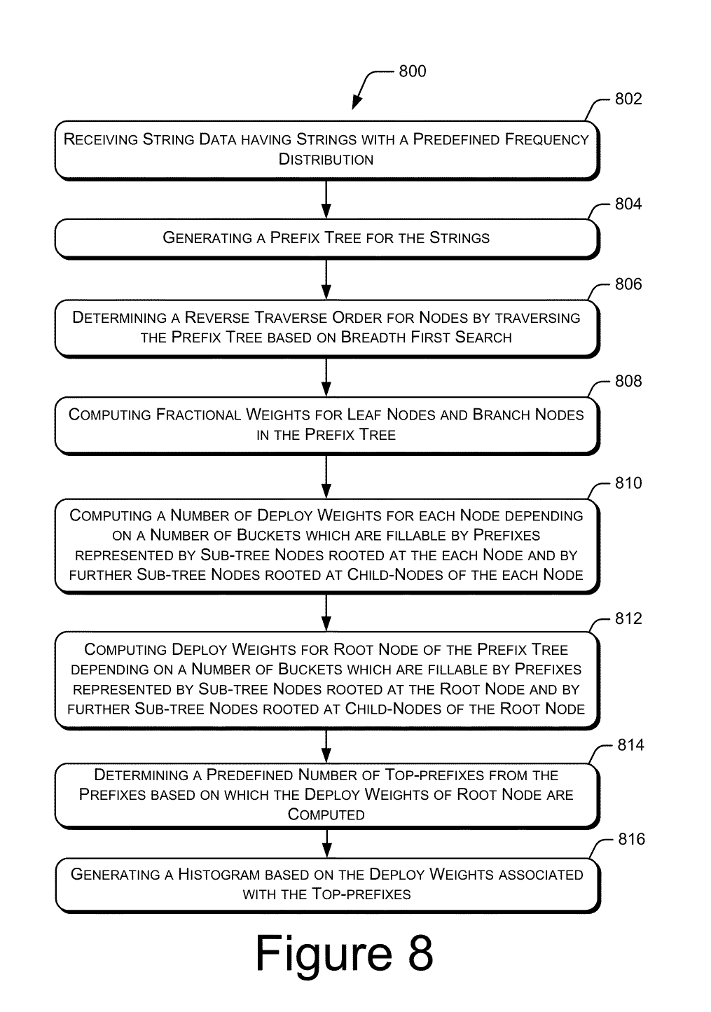

FIG. 6 illustrates a method 600 of generation of a histogram for string data, according to an example of the present subject matter. FIG. 7 illustrates a method 700 of generation of a histogram for string data in an online environment, according to an example of the present subject matter. FIG. 8 illustrates a method 800 of generation of a histogram for string data in an offline environment, according to an example of the present subject matter. The order in which the methods 600, 700, and 800 are described is not intended to be construed as a limitation, and any number of the described method blocks can be combined in any order to implement the methods 600, 700, and 800, or an alternative method. Additionally, individual blocks may be deleted from the methods 600, 700, and 800 without departing from the spirit and scope of the subject matter described herein.

Furthermore, the methods 600, 700, and 800 can be implemented by processor(s) or computing devices in any suitable hardware, non-transitory machine readable instructions, or combination thereof. It may be understood that steps of the methods 600, 700, and 800 may be executed based on instructions stored in a non-transitory computer readable medium as will be readily understood. The non-transitory computer readable medium may include, for example, digital data storage media, digital memories, magnetic storage media, such as a magnetic disks and magnetic tapes, hard drives, or optically readable digital data storage media.

Further, although the methods 600, 700, and 800 may be implemented in computing devices in different network environments for generation of histograms for string data, in examples described in FIG. 6, FIG. 7, and FIG. 8, the methods 600, 700, and 800 are explained in context of the aforementioned histogram construction system 102, for ease of explanation.

Referring to FIG. 6, at block 602, a prefix tree is generated for strings in string data. The strings are received and the prefix tree is generated by the histogram construction system 102. The strings may be received in an online environment or an offline environment. The prefix tree includes nodes that represent prefixes of the received strings.

Based on the nodes in the prefix tree, deploy weights are assigned to the nodes at block 604. The deploy weights are assigned to the nodes based on lengths of the prefixes represented by sub-tree nodes rooted at the nodes and based on frequencies of the strings whose prefixes are represented by the sub-tree nodes. Each of the deploy weights of one node is indicative of a maximum weight preserved upon filling the buckets with at least one prefix represented by the sub-tree nodes rooted at that one node. The deploy weights are assigned by the histogram construction system 102.

At block 606, a predefined number of Top-prefixes of the strings are determined for filling the predefined number of buckets. The predefined number of strings is determined from the prefixes represented by the nodes based on maximizing a total weight preserved by the prefixes in the buckets and over a maximum number of strings. The Top-prefixes are determined by the histogram construction system 102.

At block 608, a histogram is generated based on the deploy weights associated with the Top-prefixes in the buckets. The histogram is generated by the histogram construction system 102. The histogram may be generated for the purposes of data mining, data analytics, and approximate query answering.

Referring to FIG. 7, the string data is received online, in real-time. The strings in the string data are serially received one-by-one. The prefix tree initially has a root node and the predefined number of buckets, that are to be filled by the Top-prefixes, are empty. At block 702, a string is received and the prefix tree is updated to include the string. At block 704, it is checked whether the string is matching with a prefix in one bucket. For this the string is compared with the prefixes in the buckets. If the string matched with a prefix in a bucket (Yes' branch from block 704), the deploy weight in the bucket having the prefix that matches with the string is incremented by 1, at block 706. The revised deploy weight is assigned to the bucket, and the method 700 proceeds to receive the next string for processing and/or proceeds to generate a histogram at block 720.

If the string is not matched (‘No’ branch from block 704), it is checked at block 708 whether an empty or unfilled bucket, from the maximum of predefined number of buckets, exists. If an unfilled bucket is found (Yes' branch from block 708), a longest prefix of the string is filled in the unfilled bucket and the deploy weight of the node representing the longest prefix is stored in the unfilled bucket, at block 710. For this, the deploy weight is assigned to the node representing the longest prefix, based on the frequency of the string, before storing the same in the unfilled bucket. The method 700 then proceeds to receive the next string for processing and/or proceeds to generate a histogram at block 720.

Further, if no unfilled bucket is found (‘No’ branch from block 708), a bucket pair with prefixes is identified, at block 712, for which a loss weight is minimum. For this, a loss weight for each bucket pair is computed as described earlier and the pair with the minimum loss weight is taken as the bucket pair for further processing.

At block 714, it is checked whether the value of loss weight for the identified bucket pair is less than 1. If the value of loss weight is ≧1 (‘No’ branch from block 714), the deploy weights in the buckets are reduced by 1, at block 716, and the method 700 proceeds to receive the next string for processing and/or proceeds to generate a histogram at block 720. And, if the value of loss weights is <1 (‘Yes’ branch from block 716), then, at block 718, one bucket of the identified bucket pair is filled by the longest common prefix of the prefixes in the bucket pair, the deploy weight in that one bucket is revised as a sum of the deploy weights associated with the prefixes in the bucket pair minus the loss weight, the other bucket of the bucket pair is filled with a longest prefix of the string, and the deploy weight of the node representing the longest prefix of the string is stored in that other bucket. For this, the deploy weight is assigned to the node representing the longest prefix of the string, based on the frequency of the string, before storing the same in the bucket. The method 700 then proceeds to receive the next string for processing and/or proceeds to generate a histogram at block 720.

At block 720, a histogram is generated based on the deploy weights associated with the prefixes in the buckets.

Referring to FIG. 8, at block 802, string data having strings with a predefined frequency distribution is received. The string data is received offline, and the strings are static strings with fixed frequencies. At block 804, a prefix tree is generated for the received strings. The prefix tree is generated for distinct strings. Based on the prefix tree, a breadth first is performed to traverse the prefix tree and a reverse traverse order for the nodes is determined, at block 806.

Based on the reverse traverse order, fractional weights for the leaf nodes and the branch nodes in the prefix tree are computed, at block 808. After this, at block 810, a number of deploy weights are computed and assigned to each node. The deploy weights are computed for each node depending on the number of buckets, from 1 to at most the predefined number, which can be filled by the prefixes at sub-tree nodes rooted at that each node and by the prefixes at further sub-tree nodes rooted at child-nodes of that each node. The deploy weights for the nodes are computed based on the reverse traverse order and based on the fractional weights of the sub-tree nodes, frequencies of the strings whose prefixes are represented by the sub-tree nodes, lengths of the prefixes represented by the sub-tree nodes, and the deploy weights of sub-tree nodes.

At block 812, deploy weights are computed for the root node of the prefix tree. The deploy weights of the root node are computed for the number of buckets, from 1 to at most the predefined number, which can be filled by the prefixes at sub-tree nodes rooted at the root node and at the further sub-tree nodes rooted at the child-nodes of those sub-tree nodes. The deploy weights for the root node are computed based on the deploy weights of the sub-tree nodes rooted at the root node.

Based on the deploy weights of the root node, at block 814, the predefined number of Top-prefixes is determined from the prefixes based on which deploy weights of the root node are computed. The predefined number of Top-prefixes is a number indicating those prefixes represented by the sub-tree nodes at the root nodes and the prefixes represented by further sub-tree nodes at the child-nodes rooted at the sub-tree nodes for which the deploy weight of the root nodes indicates a maximum weight preserved upon filling the predefined number of buckets.

At block 816, a histogram is generated based on the deploy weights associated with the predefined number of Top-prefixes determined based on the deploy weights of the root node.

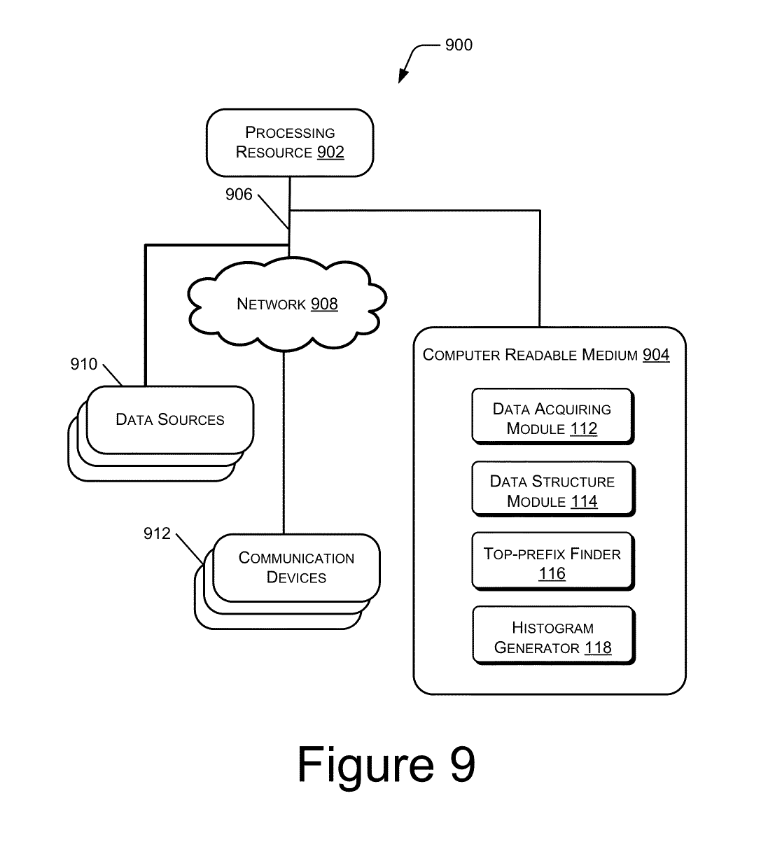

FIG. 9 illustrates a system environment 900 for generation of a histogram for string data, according to an example of the present subject matter. The system environment 900 may be a public networking environment or a private networking environment. In one implementation, the system environment 900 includes a processing resource 902 communicatively coupled to a computer readable medium 904 through a communication link 906.

For example, the processing resource 902 can be a computing device for generating histograms. The computer readable medium 904 can be, for example, an internal memory device or an external memory device. In one implementation, the communication link 906 may be a direct communication link, such as any memory read/write interface. In another implementation, the communication link 906 may be an indirect communication link, such as a network interface. In such a case, the processing device 902 can access the computer readable medium 904 through a network 908. The network 908 may be a single network or a combination of multiple networks and may use a variety of different communication protocols.

The processing resource 902 and the computer readable medium 904 may also be communicatively coupled to data sources 910 through the communication link 906, and/or to communication devices 912 over the network 908. The coupling with the data sources 910 enables in receiving the string data in an offline environment, and the coupling with the communication devices 912 enables in receiving the string data in an online environment.

In one implementation, the computer readable medium 904 includes a set of computer readable instructions, such as the data acquiring module 112, the data structure module 114, the Top-prefix finder 116, and the histogram generator 118. The set of computer readable instructions can be accessed by the processing resource 902 through the communication link 906 and subsequently executed to perform acts for generating histograms for string data.

For example, the data acquiring module 112 can obtain string data comprising strings. Based on the obtained strings, the data structure module 114 can generate a prefix tree for distributing the strings into nodes that represent prefixes of the strings. Based on the nodes in the prefix tree, the Top-prefix finder 116 can assign deploy weights to the nodes.

Further, based on the deploy weights of the nodes, the Top-prefix finder 116 can determine or find a predefined number of Top-prefixes of the strings for filling up the predefined number of buckets. The Top-prefixes are determined from the prefixes in the prefix tree, based on maximization of a total weight preserved by the predefined number of prefixes, where the predefined number of prefixes is associated with a maximum number of distinct strings. Each of the Top-prefixes is filled in a separate bucket, and the deploy weight of the node representing the each Top-prefix is stored in the corresponding bucket.

Further, after determining or finding the Top-prefixes for the strings and filling up the buckets, the histogram generator 118 can generate a histogram of the Top-prefixes. The histogram is generated based on the Top-prefixes and the deploy weights associated with the Top-prefixes.

Although implementations for generation of histograms for string data have been described in language specific to structural features and/or methods, it is to be understood that the appended claims are not necessarily limited to the specific features or methods described. Rather, the specific features and methods are disclosed and explained as example implementations for generation of histograms for string data.

We claim:

1. A method of generation of a histogram for string data having strings, the method comprising:
generating, by a computing device, a prefix tree having nodes representing prefixes of the strings, the nodes comprising leaf nodes representing longest prefixes of the strings and branch nodes representing longest common prefixes of prefixes represented by child-nodes branching out from the respective branch nodes;
assigning, by the computing device, deploy weights to the nodes based on lengths of prefixes represented by sub-tree nodes rooted at the nodes and frequencies of the strings whose prefixes are represented by the sub-tree nodes, wherein each of the deploy weights of one node is indicative of a maximum weight preserved upon filling the buckets with at least one prefix represented by the sub-tree nodes rooted at that one node;
determining, by the computing device, a predefined number of Top-prefixes of the strings for filling up the predefined number of buckets, wherein the Top-prefixes are determined from the prefixes represented by the nodes based on maximizing a total weight preserved by the prefixes in the buckets and over a maximum number of strings; and
generating a histogram based on the deploy weights associated with the Top-prefixes in the buckets.

2. The method as claimed in claim 1, wherein the strings are data streams received online in real-time by the computing device from at least one communication device, and wherein the generating the prefix tree comprises iteratively revising the prefix tree to include the strings, one by one, in the prefix tree, and wherein the determining the predefined number of Top-prefixes comprises updating the buckets for each revision of the prefix tree to maximize the total weight preserved by the Top-prefixes in the buckets.

3. The method as claimed in claim 2, wherein the updating of the buckets comprises:
for each of the strings, comparing the each string with the prefixes in the buckets, and revising, based on a frequency of the each string, the deploy weight in the bucket having the prefix that matches with the each string; and
when the each string is not matched, finding an unfilled bucket, filling a longest prefix of the each string in the unfilled bucket, and storing the deploy weight of the node representing the longest prefix in the unfilled bucket.

4. The method as claimed in claim 3, wherein, when each of the strings is not matched with the prefixes in the buckets and no bucket is unfilled, the updating of the buckets comprises:
identifying a bucket pair with prefixes for which a loss weight is minimum, wherein the loss weight is indicative of a loss in weight preserved upon filling one bucket of the bucket pair with a longest common prefix associated with the prefixes in the bucket pair and releasing another bucket of the bucket pair; and
revising the buckets based on the loss weight.

5. The method as claimed in claim 4, wherein the revising of the buckets comprises:
reducing the deploy weights in the buckets by a value of one when the loss weight has a value of at least one; and
when the loss weight has a value of less than one,
filling one bucket of the bucket pair with the longest common prefix associated with the prefixes in the bucket pair;
revising the deploy weight in the one bucket as a sum of the deploy weights associated with the prefixes in the bucket pair minus the loss weight;
filling another bucket of the bucket pair with a longest prefix of the each string; and
storing the deploy weight of the node representing the longest prefix in that other bucket.

6. The method as claimed in claim 1, wherein the strings are static strings with a predetermined frequency distribution obtained by the computing device from at least one data source, and wherein the assigning the deploy weights to the nodes is based on a reverse traverse order for the nodes and based on frequencies of the strings as in the predetermined frequency distribution.

7. The method as claimed in claim 6, further comprising determining the reverse traverse order by traversing the prefix tree based on a breadth first search.

8. The method as claimed in claim 6, wherein the assigning of the deploy weights to the nodes is based on the reverse traverse order, wherein the assigning comprises:
computing a number of deploy weights for each of the nodes depending on a number of buckets, from one to at most the predefined number, which are fillable by prefixes represented by sub-tree nodes rooted at the each node and by further sub-tree nodes rooted at child-nodes of the each node.

9. The method as claimed in claim 8, wherein the assigning of the deploy weights to the nodes comprises computing deploy weights for a root node of the prefix tree depending on a number of buckets, from one to at most the predefined number, which are fillable by prefixes represented by sub-tree nodes rooted at the root node and by further sub-tree nodes rooted at child-nodes of the root node, wherein the deploy weights of the root node are computed based on the deploy weights of nodes rooted at the root node, and wherein the Top-prefixes are determined from the prefixes based on which deploy weights of the root node are computed.

10. A histogram construction system (102) for generation of a histogram for string data, the histogram construction system (102) comprising:
a processor (110);
a data acquiring module (112) coupled to the processor (110) to obtain the string data comprising strings;
a data structure module (114) coupled to the processor (110) to generate a prefix tree comprising nodes that represent prefixes of the strings;
a Top-prefix finder (116) coupled to the processor (110) to:
assign deploy weights to the nodes based on lengths of prefixes represented by sub-tree nodes rooted at the each node and frequencies of the strings whose prefixes are represented by the sub-tree nodes, wherein each of the deploy weights of one node is indicative of a maximum weight preserved upon filling buckets with at least one prefix represented by the sub-tree nodes rooted at that one node; and
determine a predefined number of Top-prefixes of the strings for filling up the predefined number of buckets, wherein the Top-prefixes are determined from the prefixes represented by the nodes based on maximizing a total weight preserved by the prefixes in the buckets over a maximum number of strings; and
a histogram generator (118) coupled to the processor (110) to generate a histogram based on the deploy weights of the nodes representing the Top-prefixes.

11. The histogram construction system (102) as claimed in claim 10, wherein the strings are streamed and received online in real-time from at least one communication device (106), wherein the data structure module (114) iteratively revises the prefix tree to include the strings, one by one, in the prefix tree, and wherein the Top-prefix finder (116), for each revision of the prefix tree, updates the buckets to maximize the total weight preserved by the Top-prefixes in the buckets.

12. The histogram construction system (102) as claimed in claim 11, wherein the Top-prefix finder (116):
compares each of the strings with the prefixes in the buckets, and revises the deploy weight in the bucket having the prefix that matches with the each string;
finds an unfilled bucket when the each string is not matched, fills a longest prefix of the each string in the unfilled bucket, and stores the deploy weight of the node representing the longest prefix in the unfilled bucket;
identifies a bucket pair with prefixes for which a loss weight is minimum when the each string is not matched with the prefixes in the buckets and no bucket is unfilled, wherein the loss weight is indicative of a loss in weight preserved upon filling one bucket of the bucket pair with a longest common prefix associated with the prefixes in the bucket pair and releasing another bucket of the bucket pair; and
revises the buckets based on the loss weight.

13. The histogram construction system (102) as claimed in claim 12, wherein, for revising the buckets, the Top-prefix finder (116):
reduces the deploy weights in the buckets by a value of one when the loss weight has a value of at least one; and
when the loss weight has a value of less than one;
fills one bucket of the bucket pair with the longest common prefix associated with the prefixes in the bucket pair;
revises the deploy weight in the one bucket as a sum of the deploy weights associated with the prefixes in the bucket pair minus the loss weight;
fills another bucket of the bucket pair with a longest prefix of the each string; and
stores the deploy weight of the node representing the longest prefix in that other bucket.

14. The histogram construction system (102) as claimed in claim 10, wherein the strings are static strings with a predetermined frequency distribution received from at least one data source (104), and wherein the Top-prefix finder (116) assigns the deploy weights to the nodes based on a reverse traverse order of the nodes and based on frequencies of the strings as in the predetermined frequency distribution.

15. The histogram construction system (102) as claimed in claim 14, wherein the Top-prefix finder (116) computes a number of deploy weights for each of the nodes based on the reverse traverse order and depending on a number of buckets, from one to at most the predefined number, which are fillable by prefixes represented by sub-tree nodes rooted at the each node and by further sub-tree nodes rooted at child-nodes of the each node.

16. The histogram construction system (102) as claimed in claim 15, wherein the Top-prefix finder (116) computes deploy weights for a root node of the prefix tree depending on a number of buckets, from one to at most the predefined number, which are fillable by prefixes represented by sub-tree nodes rooted at the root node and by further sub-tree nodes rooted at child-nodes of the root node, wherein the deploy weights of the root are computed based on the deploy weights of nodes rooted at the root node, and wherein the Top-prefixes are determined from the prefixes based on which the deploy weights of the root node are computed.

17. A non-transitory computer-readable medium comprising computer readable instructions that, when executed, cause a histogram construction system to:
obtain string data comprising strings;
determine a predefined number of Top-prefixes of the strings for filling up the predefined number of buckets, by:
generating a prefix tree having nodes representing prefixes of the strings, the nodes comprising leaf nodes representing longest prefixes of the strings and branch nodes representing longest common prefixes of prefixes represented by child-nodes branching out from the respective branch node; and
assigning deploy weights to the nodes based on lengths of the prefixes represented by sub-tree nodes rooted at the each node and frequencies of the strings whose prefixes are represented by the sub-tree nodes, wherein each of the deploy weights of one node is indicative of a maximum weight preserved upon filling the buckets with at least one prefix represented by the sub-tree nodes rooted at that one node;
wherein the Top-prefixes are determined from the prefixes represented by the nodes based on maximizing a total weight preserved by the prefixes in the buckets over a maximum number of strings; and
generate a histogram based on the deploy weights associated with the Top-prefixes in the buckets.
